(19) United States
(12) Patent Application Publication
(10) Pub. No.: US 2022/0268466 A1
(43) Pub. Date: Aug. 25, 2022

(54) Collapsible Smoke Containment Apparatus

(71) Applicant: John Doerr, Clarksville, TN (US)

(72) Inventor: John Doerr, Clarksville, TN (US)

(21) Appl. No.: 17/183,842

(22) Filed: Feb. 24, 2021

(51) Int. Cl. F24F 8/97; E04B 1/343; E04H 1/12; F24F 7/003; B01D 46/00; B01D 39/20; B01D 39/16

(52) U.S. Cl. CPC F24F 8/97; E04B 1/34326; E04H 1/125; F24F 7/003; B01D 46/002; B01D 46/0023; B01D 46/0043; B01D 46/0049; B01D 46/0002; B01D 39/2027; B01D 39/2055; B01D 39/16; E04H 2001/1294; B01D 2273/30; B01D 2279/35

(57) ABSTRACT

A collapsible smoke containment apparatus for safe and accessible smoking includes a floor having a ramp. A frame includes a frame front side, a frame back side, a frame left side, and a frame right side each coupled to a frame base. The frame front side has a door aperture aligned with a pair of ramp outer edges of the ramp. A door is coupled to the frame. A film cover is coupled to the frame and has a cover front side, a cover back side, a cover left side, a cover right side, and a cover top side. The film cover has a plurality of cover apertures extending therethrough. Each of a plurality of filter units comprises a filter housing coupled to the film cover around one of the cover apertures. A recirculating fan and a ventilation fan are coupled within the filter housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to smoke house devices and more particularly pertains to a new smoke house device for safe and accessible smoking. The present invention includes a collapsible frame and a ramped floor. The present invention also includes a film cover with a plurality of vent apertures to selectively receive a plurality of ventilation units.

### (2) Description of Related Art including information disclosed under 37 CFR 1.97 and 1.98.

The prior art relates to smoke house devices. Existing devices lack a ramped floor for wheelchair access. These known devices also lack a plurality of attachable ventilation units directly onto a film cover.

### BRIEF SUMMARY OF THE INVENTION

An embodiment of the disclosure meets the needs presented above by generally comprising a floor having a floor top side, a floor bottom side, and a floor edge. A ramp is coupled to the floor edge. A frame is coupled to the floor. The frame includes a frame front side, a frame back side, a frame left side, and a frame right side each coupled to a frame base and defining a frame top side. The frame base is coupled to the floor top side. The frame front side has a door aperture aligned with a pair of ramp outer edges of the ramp. A door is coupled to the frame. The door is hingingly coupled adjacent the door aperture to selectively seal or expose the door aperture. A film cover is coupled to the frame. The film cover has a cover front side, a cover back side, a cover left side, a cover right side, and a cover top side coupled to the frame front side, the frame back side, the frame left side, the frame right side, and the frame top side, respectively. The film cover has a plurality of cover apertures extending therethrough. A plurality of filter units is coupled to the film cover. Each filter unit comprises a filter housing coupled to the film cover around one of the cover apertures. A recirculating fan is coupled within the filter housing to recirculate air from within the film cover. A plurality of recirculating filters is coupled within the filter housing adjacent the recirculating fan. A ventilation fan is coupled within the filter housing to draw outside air into the film cover. A plurality of ventilation filters is coupled within the filter housing adjacent the ventilation fan.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a collapsible smoke containment apparatus according to an embodiment of the disclosure.

FIG. 2 is an isometric view of an embodiment of the disclosure.

FIG. 3 is an isometric view of an embodiment of the disclosure.

FIG. 4 is a side elevation view of an embodiment of the disclosure.

FIG. 5 is a front elevation view of an embodiment of the disclosure.

FIG. 6 is a top plan view of an embodiment of the disclosure.

FIG. 7 is a cross-sectional view of an embodiment of the disclosure along the line 7-7 of FIG. 4.

FIG. 8 is a cross-sectional view of an embodiment of the disclosure along the line 8-8 of FIG. 4.

### DETAILED DESCRIPTION OF THE INVENTION

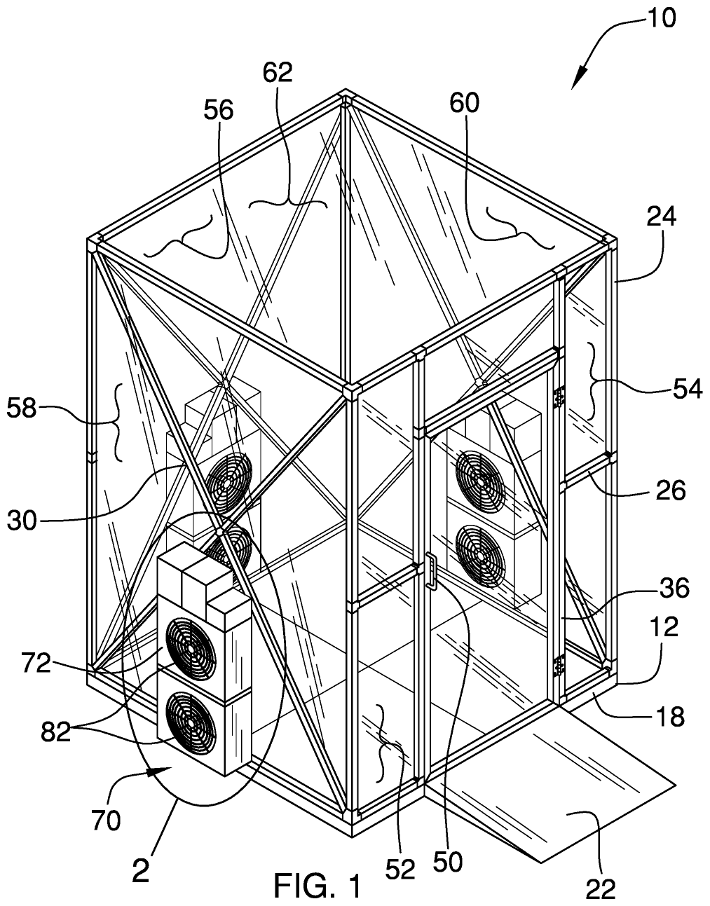

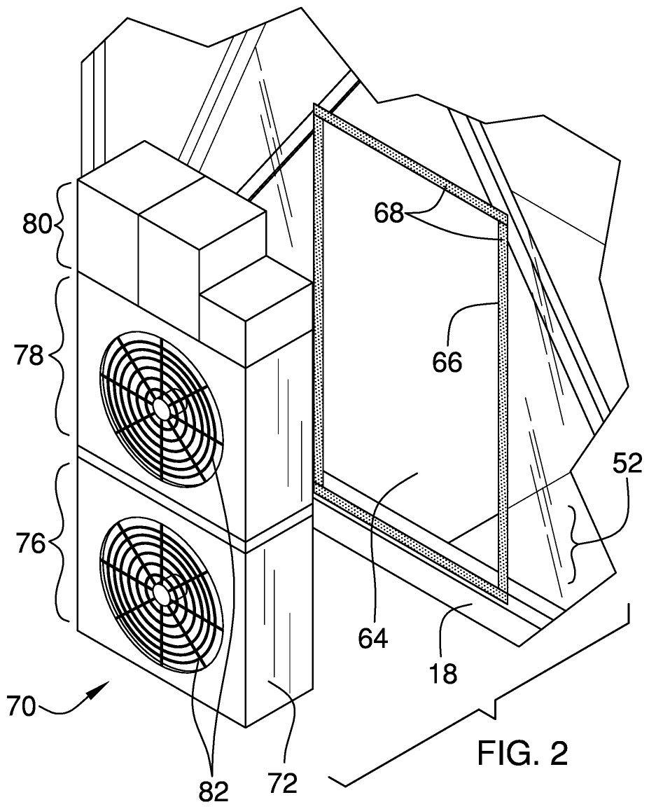

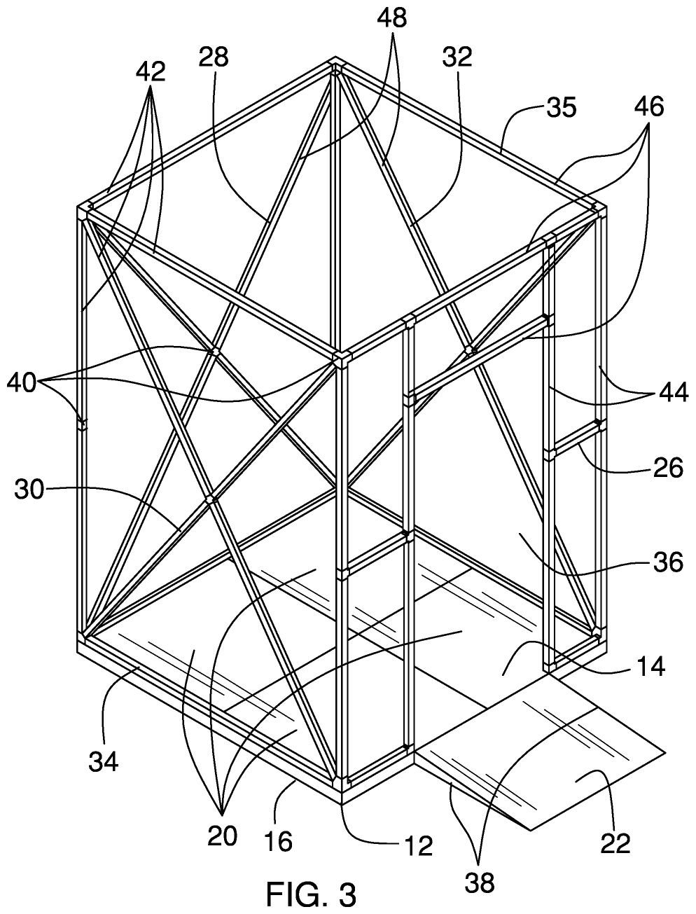

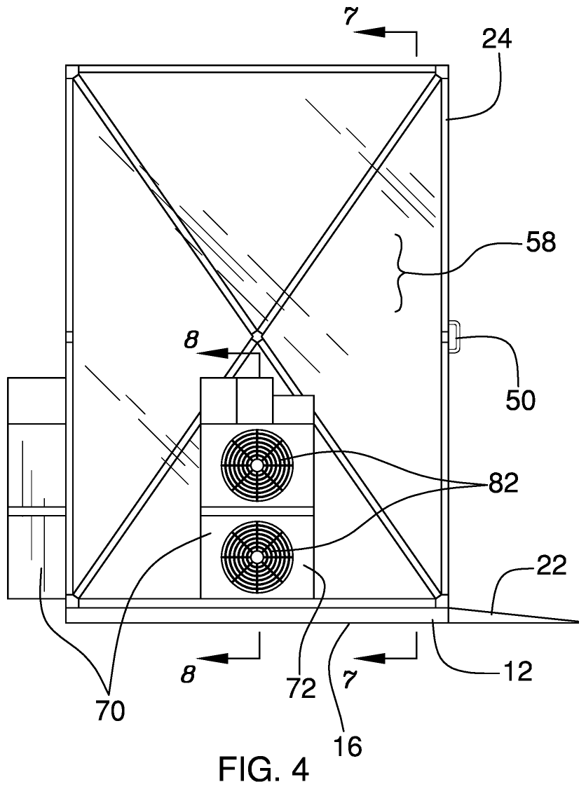

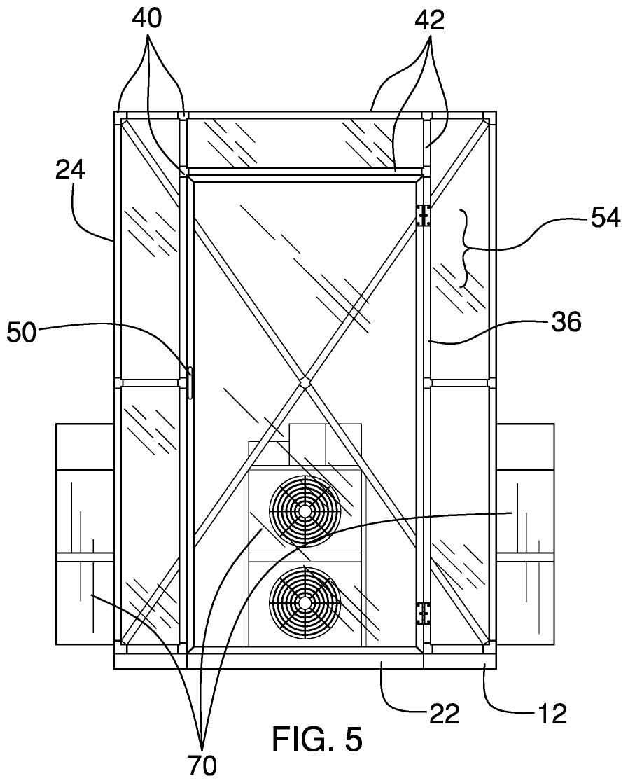

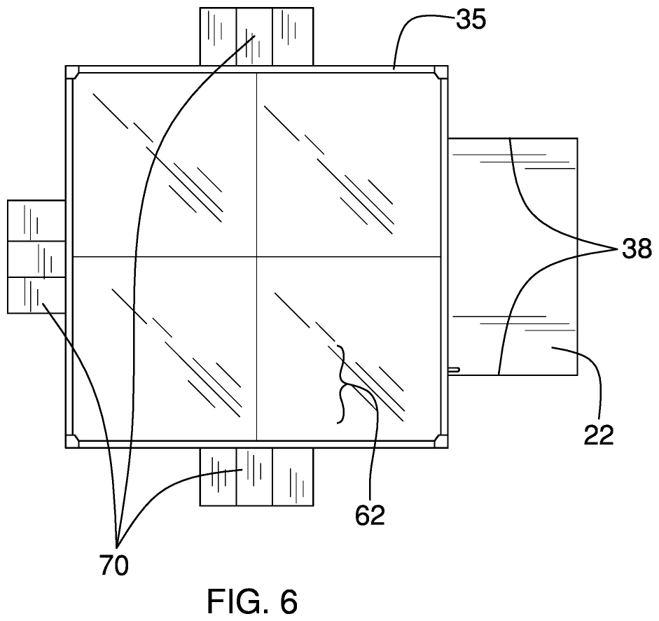

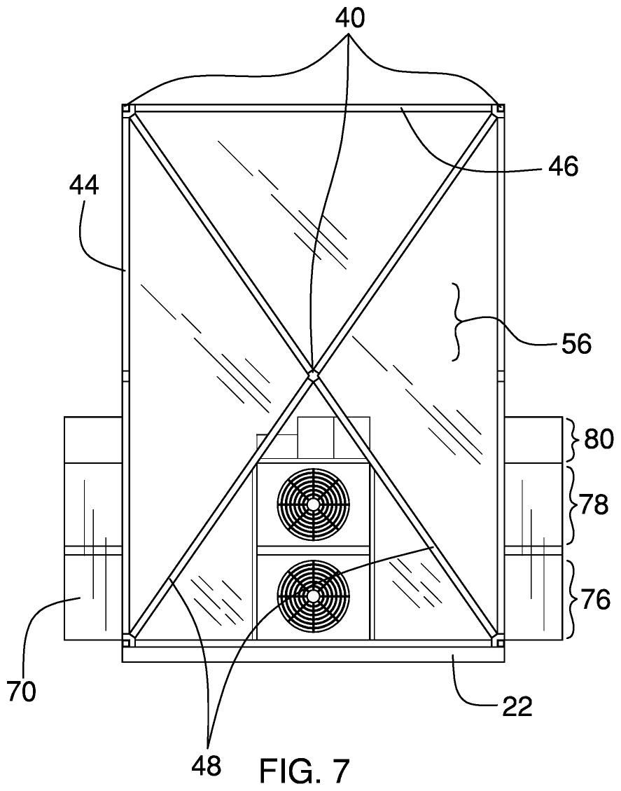

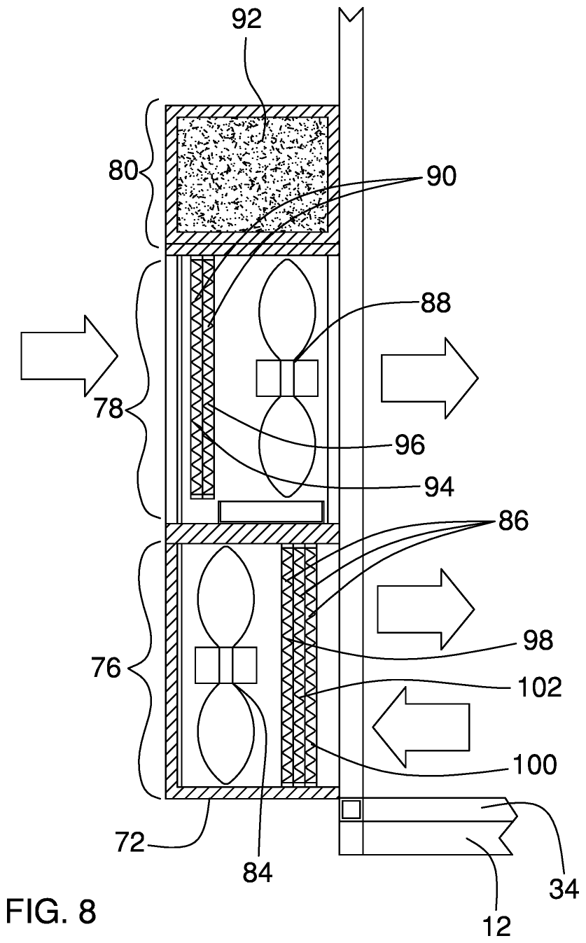

With reference now to the drawings, and in particular to FIGS. 1 through 8 thereof, a new smoke house device embodying the principles and concepts of an embodiment of the disclosure and generally designated by the reference numeral 10 will be described.

As best illustrated in FIGS. 1 through 8, the collapsible smoke containment apparatus 10 generally comprises a floor 12 having a floor top side 14, a floor bottom side 16, and a floor edge 18. The floor 12 may comprise a plurality of joinable flooring sections 20. A ramp 22 is coupled to the floor edge 18 to provide wheelchair access.

A frame 24 is coupled to the floor 12. The frame 24 includes a frame front side 26, a frame back side 28, a frame left side 30, and a frame right side 32 each coupled to a frame base 34 and defining a frame top side 35. The frame base 34 is coupled to the floor top side 14. The frame front side 26 has a door aperture 36 aligned with a pair of ramp outer edges 38 of the ramp. The frame 24 may include a plurality of connector pieces 40 and a plurality of bars 42. The plurality of bars 42 includes a plurality of vertical bars 44, a plurality of horizontal bars 46, and a plurality of angled cross bars 48. A door 50 is coupled to the frame 24. The door 50 is hingingly coupled adjacent the door aperture 36 to selectively seal or expose the door aperture 36.

A film cover 52 is coupled to the frame 24. The film cover 52 has a cover front side 54, a cover back side 56, a cover left side 58, a cover right side 60, and a cover top side 62 coupled to the frame front side 26, the frame back side 28, the frame left side 30, the frame right side 32, and the frame top side 35, respectively. The film cover 52 has a plurality of cover apertures 64 extending therethrough. The plurality of cover apertures 64 may extend through the cover back side 56, the cover left side 58, and the cover right side 60 beneath a pair of the angled cross bars 48. A perimeter 66 of each of the cover apertures may have a plurality of first engagement members 68.

A plurality of filter units 70 is coupled to the film cover 52. Each filter unit comprises a filter housing 72 coupled to the film cover 52 around one of the cover apertures 64. The filter housing 72 has a plurality of second engagement members 74 to selectively engage the plurality of first engagement members 68. The plurality of first engagement members 68 and the plurality of second engagement members 74 may be, but are not limited to, selectively engageable fasteners such as hook-and-loop fasteners, adhesives, and the like. The filter housing 72 may form a lower chamber 76, a medial chamber 78, and an upper chamber 80. The filter housing 72 may have a pair of grated intake apertures 82.

A recirculating fan 84 is coupled within the filter housing 72. The recirculating fan 84 is coupled within the lower chamber 76 to recirculate air from within the film cover 52. A plurality of recirculating filters 86 is coupled within the filter housing 72 adjacent the recirculating fan 84. A ventilation fan 88 is coupled within the filter housing 72. The ventilation fan 88 is coupled within the medial chamber 78 to draw outside air into the film cover 52. A plurality of ventilation filters 90 is coupled within the filter housing 72 adjacent the ventilation fan 88. A cleaning filter 92 may be coupled within the upper chamber 80. The plurality of ventilation filters 90 may include a first metal filter 94 and a first hemp filter 96. The plurality of recirculating filters 86 may include a second metal filter 98, a second hemp filter 100, and a first charcoal filter 102 positioned therebetween.

In use, the user may place a smoker within the film cover 52 to smoke anything desired. The ventilation fan 88 and the recirculating fan 84 provide airflow while maintaining all smoke within the film cover 52 to prevent smoke release causing harm. The ramp 22 provides access to the floor 12 for wheelchairs.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A collapsible smoke containment apparatus comprising:
a floor having a floor top side, a floor bottom side, and a floor edge;
a ramp coupled to the floor, the ramp being coupled to the floor edge;
a frame coupled to the floor, the frame including a frame front side, a frame back side, a frame left side, and a frame right side each coupled to a frame base and defining a frame top side, the frame base being coupled to the floor top side, the frame front side having a door aperture aligned with a pair of ramp outer edges of the ramp;
a door coupled to the frame, the door being hingingly coupled adjacent the door aperture to selectively seal or expose the door aperture;
a film cover coupled to the frame, the film cover having a cover front side, a cover back side, a cover left side, a cover right side, and a cover top side coupled to the frame front side, the frame back side, the frame left side, the frame right side, and the frame top side, respectively, the film cover having a plurality of cover apertures extending therethrough; and
a plurality of filter units coupled to the film cover, each filter unit comprising:
a filter housing coupled to the film cover around one of the cover apertures;
a recirculating fan coupled within the filter housing, the recirculating fan recirculating air from within the film cover;
a plurality of recirculating filters coupled within the filter housing adjacent the recirculating fan;
a ventilation fan coupled within the filter housing, the ventilation air drawing outside air into the film cover; and
a plurality of ventilation filters coupled within the filter housing adjacent the ventilation fan.

2. The collapsible smoke containment apparatus of claim 1 further comprising the floor comprising a plurality of joinable flooring sections.

3. The collapsible smoke containment apparatus of claim 1 further comprising the frame including a plurality of connector pieces and a plurality of bars.

4. The collapsible smoke containment apparatus of claim 3 further comprising the plurality of bars including a plurality of vertical bars, a plurality of horizontal bars, and a plurality of angled cross bars.

5. The collapsible smoke containment apparatus of claim 4 further comprising the plurality of cover apertures extending through the cover back side, the cover left side, and the cover right side beneath a pair of the angled cross bars.

6. The collapsible smoke containment apparatus of claim 1 further comprising a perimeter of each of the cover apertures having a plurality of first engagement members; the filter housing having a plurality of second engagement members to selectively engage the plurality of first engagement members.

7. The collapsible smoke containment apparatus of claim 6 further comprising the plurality of first engagement members and the plurality of second engagement members being hook-and-loop fasteners.

8. The collapsible smoke containment apparatus of claim 1 further comprising the filter housing forming a lower chamber, a medial chamber, and an upper chamber; the recirculating fan and the plurality of recirculating filters being coupled within the lower chamber, the ventilation fan and the plurality of ventilation filters being coupled within the medial chamber, and a cleaning filter being coupled within the upper chamber.

9. The collapsible smoke containment apparatus of claim 8 further comprising the filter housing having a pair of grated intake apertures.

10. A collapsible smoke containment apparatus comprising:
a floor having a floor top side, a floor bottom side, and a floor edge, the floor comprising a plurality of joinable flooring sections;
a ramp coupled to the floor, the ramp being coupled to the floor edge;
a frame coupled to the floor, the frame including a frame front side, a frame back side, a frame left side, and a frame right side each coupled to a frame base and defining a frame top side, the frame base being coupled to the floor top side, the frame front side having a door aperture aligned with a pair of ramp outer edges of the ramp, the frame including a plurality of connector pieces and a plurality of bars, the plurality of bars including a plurality of vertical bars, a plurality of horizontal bars, and a plurality of angled cross bars;
a door coupled to the frame, the door being hingingly coupled adjacent the door aperture to selectively seal or expose the door aperture;
a film cover coupled to the frame, the film cover having a cover front side, a cover back side, a cover left side, a cover right side, and a cover top side coupled to the frame front side, the frame back side, the frame left side, the frame right side, and the frame top side, respectively, the film cover having a plurality of cover apertures extending therethrough, the plurality of cover apertures extending through the cover back side, the cover left side, and the cover right side beneath a pair of the angled cross bars, a perimeter of each of the cover apertures having a plurality of first engagement members; and
a plurality of filter units coupled to the film cover, each filter unit comprising:
a filter housing coupled to the film cover around one of the cover apertures, the filter housing having a plurality of second engagement members to selectively engage the plurality of first engagement members, the plurality of first engagement members and the plurality of second engagement members being hook-and-loop fasteners, the filter housing forming a lower chamber, a medial chamber, and an upper chamber, the filter housing having a pair of grated intake apertures;
a recirculating fan coupled within the filter housing, the recirculating fan being coupled within the lower chamber, the recirculating fan recirculating air from within the film cover;
a plurality of recirculating filters coupled within the filter housing adjacent the recirculating fan;
a ventilation fan coupled within the filter housing, the ventilation fan being coupled within the medial chamber, the ventilation air drawing outside air into the film cover;
a plurality of ventilation filters coupled within the filter housing adjacent the ventilation fan; and
a cleaning filter coupled within the upper chamber.
